(19) United States
(12) Patent Application Publication
(10) Pub. No.: US 2025/0337782 A1
(43) Pub. Date: Oct. 30, 2025

(54) MANAGING OPERATION OF A DATA PROCESSING SYSTEM USING DETECTION CRITERIA FOR TRAFFIC ACROSS AN OUT-OF-BAND COMMUNICATION CHANNEL

(71) Applicant: Dell Products L.P., Round Rock, TX (US)

(72) Inventors: RICHARD M. TONRY, Georgetown, TX (US); ABEYE TESHOME, Austin, TX (US); BASSEM EL-AZZAMI, Austin, TX (US); MOHIT ARORA, Frisco, TX (US); VINODKUMAR VASUDEV OTTAR, McKinney, TX (US); LUIS ANTONIO VALENCIA REYES, Waxahachie, TX (US); ADOLFO SANDOR MONTERO, Pflugerville, TX (US); RAJARAVI CHANDRA KOLLARAPU, Allen, TX (US)

(21) Appl. No.: 18/649,233

(22) Filed: Apr. 29, 2024

(51) Int. Cl. H04L 9/40

(52) U.S. Cl. CPC H04L 63/18; H04L 63/1416

(57) ABSTRACT

Methods and systems for managing a data processing system are disclosed. The method may include monitoring, by a management controller of the data processing system, traffic directed across an out-of-band communication channel to obtain traffic data. The method may also include obtaining detection criteria that indicates unexpected traffic data. If traffic data meets the detection criteria, then the traffic data may indicate that the out-of-band communication channel is in a potentially compromised state. Therefore, the management controller may generate an alert and initiate performance of one or more actions to update operation of the data processing system to place the data processing system in a second operating state that is less likely to be impacted by the potentially compromised state of the out-of-band communication channel that if the data processing system was operation in the first operating state.

### FIELD

Embodiments disclosed herein relate generally to managing a data processing system. More particularly, embodiments disclosed herein relate to managing a data processing system using detection criteria for traffic across an out-of-band communication channel.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1B show diagrams illustrating a system in accordance with an embodiment.

FIGS. 2A-2C show data flow diagrams in accordance with an embodiment.

FIGS. 3A-3C show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing a data processing system. The data processing system may provide computer-implemented services to any type and number of other devices and/or users of the data processing system. The computer-implemented services may include any quantity and type of such services.

While providing the computer-implemented services, the data processing system may include and utilize hardware resources (e.g., in-band components of the data processing system) to manage operation. Because the hardware resources may be inoperable under certain conditions (e.g., an unavailability of at least a portion of the hardware resources), operation of the data processing system may also be managed by out-of-band components that may communicate with the data processing system via an out-of-band communication channel. The out-of-band components and the out-of-band communication channel may function independently from in-band components, and the out-of-band communication channel may support a management schema between a management controller of the data processing system and a server system.

However, the out-of-band communication channel may be subject to attacks by malicious entities. For example, malware may be introduced into the data processing system to perform a network attack (e.g., distributed denial of service attack) against the management controller of the data processing system. The network attack may place the out-of-band communication channel in a potentially compromised state, for example, by overwhelming the out-of-band communication channel with traffic (e.g., malicious and/or high volumes of traffic) that may disrupt the management schema and normal operation of the out-of-band communication channel. A disruption in the management schema caused by a potentially compromised state of the out-of-band communication channel may negatively impact the computer-implemented services provided by the data processing system.

To reduce a likelihood that computer-implemented services may be impacted by the potentially compromised state of the out-of-band communication channel, detection criteria may be utilized when monitoring traffic directed across the out-of-band communication channel. Traffic data that meets the detection criteria may indicate a potentially compromised state of the out-of-band communication channel and subsequently trigger an alert by the management controller of the data processing system.

The detection criteria may be obtained by identifying traffic data expected to traverse the out-of-band communication channel. The traffic data may be identified based on historic traffic data (e.g., data volumes directed across the out-of-band communication channel) collected over a period of time. The detection criteria may be, for example, a threshold for the level of traffic, an expected pattern of traffic, and/or any other criteria that may indicate normal traffic behavior.

Traffic (e.g., live traffic) directed across the out-of-band communication channel may be monitored to obtain a level of traffic. The level of traffic may be compared to the detection criteria. If the level of traffic exceeds the detection criteria, an alert may be generated by the management controller. The alert may indicate that the out-of-band communication channel is in a potentially compromised state (e.g., under a network attack).

Once obtained, the alert may be used by the management controller of the data processing system to identify a response policy keyed to the alert. The response policy may include one or more actions that when performed, may update operation of the data processing system to place the data processing system in a second operating state (e.g., by remediating a cause of the potentially compromised state of the out-of-band communication channel). While operating in the second operating state, the data processing system may provide computer-implemented services that are less likely to be impacted by the potentially compromised state of the out-of-band communication channel.

Thus, embodiments disclosed herein may provide an improved method for managing a data processing system by using detection criteria to determine whether the out-of-band communication channel may be in a compromised state and generate an alert. By doing so, a management controller of the data processing system may perform one or more actions according to a response policy to place the data processing system in a second operating state. Doing so may improve a quality and/or availability of computer-implemented services provided by the data processing system.

In an embodiment, a method for managing a data processing system is provided. The method may include (i) obtaining, by a management controller of the data processing system while the data processing system operates in a first operating state, an alert that indicates that an out-of-band communication channel is in a potentially compromised state; (ii) identifying, by the management controller, a response policy keyed to the alert, the response policy comprising one or more actions to be performed based on the alert; (iii) initiating, by the management controller, performance of the one or more actions to implement the response policy to update operation of the data processing system to place the data processing system in a second operating state; and (iv) providing, by the data processing system while operating in the second operating state, computer implemented services that are less likely to be impacted by the potentially compromised state of the out-of-band communication channel than if the data processing system was operating in the first operating state.

Obtaining the alert may include: (i) obtaining detection criteria, the detection criteria indicating unexpected traffic data; (ii) monitoring traffic directed across the out-of-band communication channel to obtain first traffic data over a first period of time, the traffic comprising messages sent between a data processing system and a server system to support operation of the data processing system; (iii) making a determination regarding whether the first traffic data meets the detection criteria; and (iv) in the first instance of the determination in which the first traffic data meets the detection criteria: (a) generating the alert.

The out-of-band communication channel may be in the potentially compromised state when the first traffic data meets the detection criteria.

Monitoring the traffic may include obtaining the first traffic data collected from the management controller of the data processing system and/or a network module of the data processing system.

Traffic data may include at least one type of traffic data selected from a group of traffic data consisting of: (i) a level of traffic directed across the out-of-band communication channel; and (ii) traffic patterns for traffic directed across the out-of-band communication channel.

Obtaining the detection criteria may include: prior to obtaining the alert: (i) collecting historic traffic data over a second period of time prior to the first period of time; (ii) analyzing the historic traffic data to identify at least an expected level of traffic likely to traverse the out-of-band communication channel or a traffic pattern likely to traverse the out-of-band communication channel; and (iii) generating the detection criteria based at least on the expected level of traffic likely to traverse the out-of-band communication channel.

The detection criteria may be updated based on additional traffic data collected over a third period of time after the first period of time.

The out-of-band communication channel may support a management schema between the management controller of the data processing system and a server system and the potentially compromised state of the out-of-band communication channel causes a disruption to the management schema.

The disruption to the management schema negatively impacts the computer implemented services provided by the data processing system while operating in the first operating state.

The one or more actions of the response policy may include at least one type of action selected from a group of actions consisting of: (i) disabling operation of a hardware resource of the data processing system to attempt to reduce impacts of the potentially compromised state; (ii) notifying an entity tasked with managing operation of the data processing system to attempt to remediate the potentially compromised state; and (iii) initiating performance of a forensics process to attempt to remediate a cause of the potentially compromised state.

The potentially compromised state may be due to a network attack, the network attack may include at least one type of attack selected from a group of types of attacks consisting of: (i) a distributed denial of service attack against the management controller; and (ii) a denial of service against the management controller.

The data processing system may include hardware resources and a network module adapted to separately advertise network endpoints for the management controller and the hardware resources of the data processing system, the network endpoints being usable by a server system to address communications to the hardware resources using an in-band communication channel and the management controller using an out-of-band communication channel.

The management controller and the network module may be on separate power domains from the hardware resources so that the management controller and the network module are operable while the hardware resources are inoperable.

The out-of-band communication channel may run through the network module, and an in-band communication channel that services the hardware resources may also run through the network module.

The network module may host a transmission control protocol/internet protocol (TCP/IP) stack to facilitate network communications via the out-of-band communication channel.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

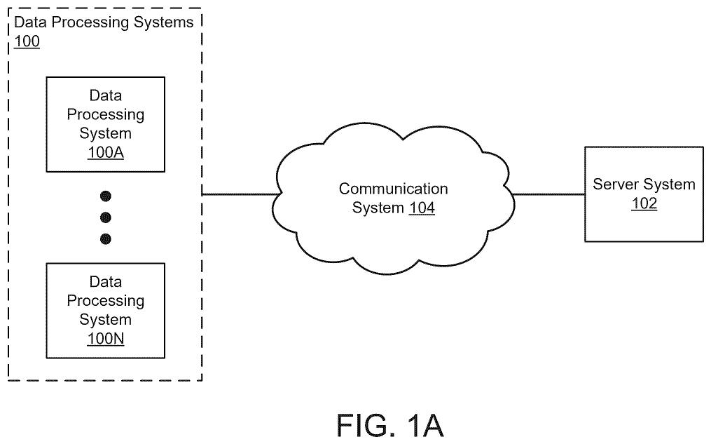

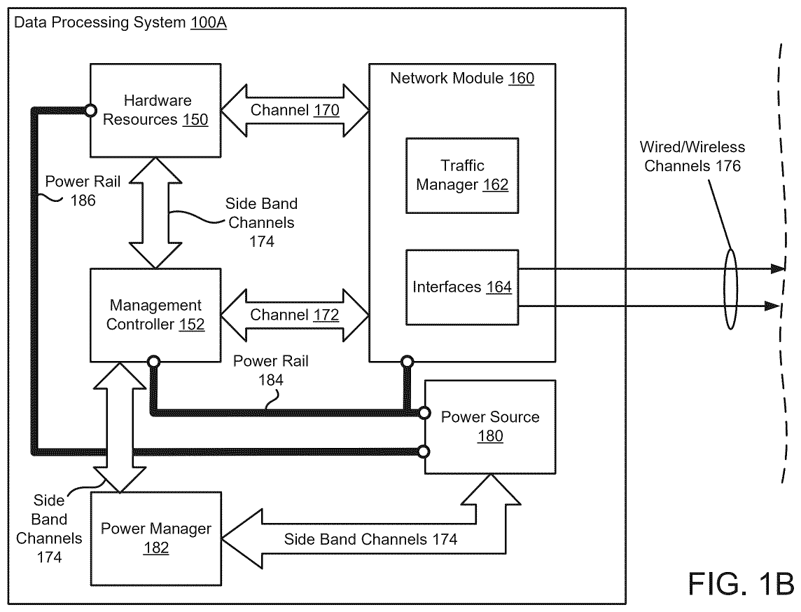

Turning to FIG. 1A, a system in accordance with an embodiment is shown. The system may provide for management of data processing systems that may provide, at least in part, computer-implemented services (e.g., to user of the system and/or devices operably connected to the system).

The system may include any number of data processing systems 100 (e.g., computing devices) that may each include any number of hardware components (e.g., processors, memory modules, storage devices, communication devices, etc.). The hardware components may support execution of any number and types of applications (e.g., software components). Changes in available functionalities of the hardware and/or software components may provide for various types of different computer-implemented services to be provided over time. Refer to FIG. 1B for additional details regarding data processing systems 100.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, server system 102, and/or any other type of devices (not shown in FIG. 1A). Other types of computer-implemented services may be provided by the system shown in FIG. 1A without departing from embodiments disclosed herein.

To manage operation of a data processing system (e.g., 100A), data processing system 100A may include a management controller. The management controller may operate independently from the hardware resources of data processing system 100A and may therefore provide management functionalities for data processing system 100A regardless of a status of one or more in-band components (e.g., the hardware resources). In addition, the management controller may receive information from and/or provide information to server system 102 without the information traversing the in-band components. To do so, data processing system 100A may include a network module.

The network module may facilitate out-of-band communications for the management controller across an out-of-band communication channel. The out-of-band communication channel may support a management schema between the management controller of data processing system 100A and server system 102. The management schema may include information usable to manage (e.g., update, notify, etc.) operation of data processing system 100A while providing computer-implemented services.

However, while providing the aforementioned computer-implemented services, data processing system 100A may encounter attacks by malicious entities (e.g., malware) attempting to disrupt operation of data processing system 100A. One or more malicious entities may disrupt operation of data processing system 100A by performing a network attack on the management controller of data processing system 100A. For example, a distributed denial of service attack on the management controller may flood an out-of-band communication channel used by the management controller with traffic (e.g., malicious and/or high volumes of traffic) that may place the out-of-band communication channel in a potentially compromised state.

A potentially compromised state of the out-of-band communication channel may disrupt the management schema between the management controller of the data processing system and a server system. Subsequently, computer-implemented services provided by the data processing system may be negatively impacted.

In general, embodiments disclosed herein may provide methods, systems, and/or devices for managing use of a data processing system. To improve a resiliency against malicious activity intended to disrupt use of the data processing system, traffic directed across an out-of-band communication channel used to manage the data processing system may be monitored to identify when a network attack may be occurring. When the network attack is identified to be occurring, a management controller of the data processing system may perform a response designed to reduce an impact of the network attack. For example, the response may be to generate an alert, identify a response policy, and/or perform actions to remediate a cause of the network attack. By doing so, an impact that a potentially compromised state of the out-of-band communication channel may have on the data processing system be reduced.

The traffic data may be obtained by monitoring traffic directed across the out-of-band communication channel (e.g., live traffic). The traffic may include messages sent between data processing system 100A and server system 102 to help manage data processing system 100A. To monitor the traffic, traffic data may be collected at points of the out-of-band communication channel that the traffic traverses. For example, the traffic may be collected by a management controller of the data processing system and/or a network module of the data processing system. The traffic data may include characteristics of traffic directed across the out-of-band communication channel (e.g., level of traffic, traffic patterns, etc.) that may be compared to detection criteria to determine whether the out-of-band communication channel may be under a network attack (e.g., distributed denial of service attack).

The detection criteria may be obtained by collecting historic traffic data over a second period of time prior to the first period of time. The historic traffic data may be collected from points of the out-of-band communication channel where traffic may traverse (e.g., the management controller of the data processing system and/or a network module of the data processing system). The historic traffic data may be analyzed to identify an expected level of traffic and/or traffic pattern likely to traverse the out-of-band communication channel (e.g., during normal operation of the out-of-band communication channel).

The detection criteria may be generated based on the expected level of traffic and/or expected traffic pattern. For example, consider a scenario in which the historic traffic data may show that a level of traffic under normal operation of the out-of-band communication channel averages 70 messages/second but may reach 120 messages/second for a maximum of 10 seconds before returning to the average of 70 messages/second. In this scenario, the detection criteria may include: (i) an average level of traffic of 80 messages/second (e.g., a buffer may be added to account for normal fluctuations in traffic) over a monitored period of time, (ii) 130 messages/second for a maximum of 12 seconds, and/or any other metrics that may indicate unexpected traffic data (e.g., variance).

While monitoring traffic directed across the out-of-band communication channel during the first period of time (e.g., live traffic) to obtain traffic data, the management controller of data processing system 100A may make a determination regarding whether the traffic data meets the detection criteria (e.g., by comparing a level of traffic and/or traffic patterns between the traffic data and the detection criteria). If the traffic data meets the detection criteria, an alert may be generated and/or obtained by the management controller. For example, if the traffic data shows a spike in traffic of 300 message/second directed across the out-of-band communication channel and the detection criteria indicates that expected traffic data has a maximum of 130 messages/second, then an alert may be generated based on the unexpected level of traffic that may be due to a network attack.

The alert may indicate that the out-of-band communication channel is in a potentially compromised state (e.g., under a network attack). The management controller may identify a response policy keyed to the alert. The response policy may include one or more actions to be performed that may be intended to remediate the potentially compromised state of the out-of-band communication channel. For example, the one or more actions may include: (i) disabling operation of a hardware resource of data processing system 100A to attempt to reduce impacts of the potentially compromised state of the out-of-band communication channel, (ii) notifying an entity (e.g., management controller of data processing system 100A, hardware resources of data processing system 100A, and/or server system 102) tasked with managing operation of data processing system 100A, (iii) initiating performance of a forensics process to attempt to remediate a cause of the potentially compromised state, and/or any other actions.

To provide the above noted functionality, the system may include data processing systems 100, and server system 102. Each of these components is discussed below.

Data processing systems 100 may include any number of data processing systems (e.g., 100A-100N) that may individually and/or cooperatively provide at least a portion of the computer-implemented services. Any of data processing systems 100 may include in-band components (e.g., hardware resources), out-of-band components (e.g., management controller, network modules, etc.), and functionality that may allow the out-of-band components to communicate with server system 102 via an out-of-band communication channel. Data processing systems 100 may utilize the out-of-band communication channel to support a management schema that allows data processing systems 100 to provide computer-implemented services.

While utilizing the out-of-band communication channel, data processing systems 100 may provide network attack detection services. To provide network attack detection services, a management controller of a data processing system (e.g., 100A) may monitor traffic during a current period of time (e.g., live traffic) directed across the out-of-band communication channel to obtain traffic data and analyze the traffic data to determine whether the traffic data meets detection criteria (e.g., a threshold for a level of traffic, unexpected traffic patterns, etc.). Data processing system 100A may obtain the detection criteria by collecting historic traffic data (e.g., over a period of time prior to the current period of time) and identifying indicators of malicious activity. When the traffic data is determined to have met the detection criteria, data processing system 100A may perform one or more actions in response to a potentially compromised state of the out-of-band communication channel (e.g., a network attack). For example, data processing system 100A may provide an alert, identify a response policy based on the alert, and implement the response policy.

Server system 102 may, as discussed above, provide remote management services. To provide remote management service, server system 102 may interact with data processing systems 100 to provide instructions regarding modifications to operation of data processing systems 100 and/or updates to the computer-implemented services provided by data processing systems 100. For example, server system 102 may send instructions relevant to management of a data processing system (e.g., 100A) across an out-of-band communication channel to a management controller of data processing system 100A. The management controller of data processing system 100A may receive and implement the instructions.

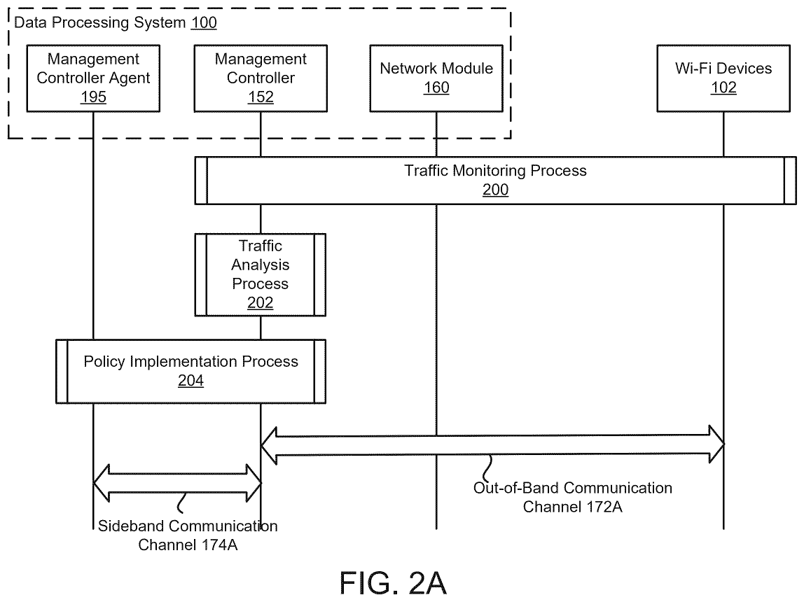

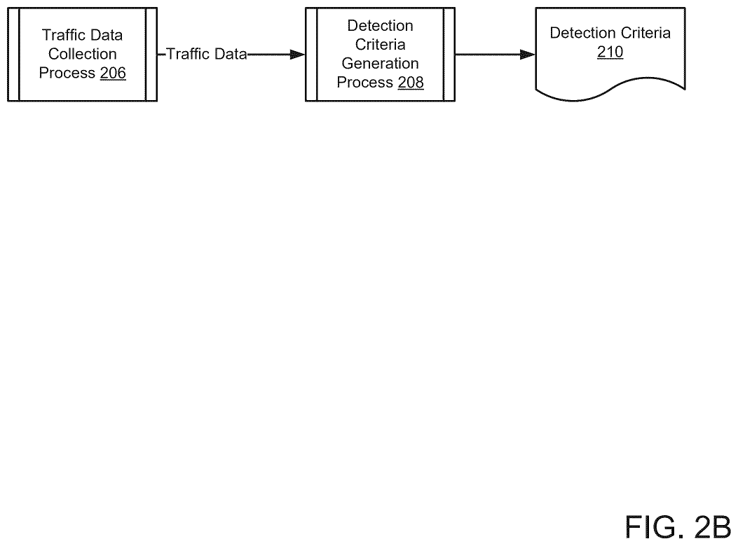

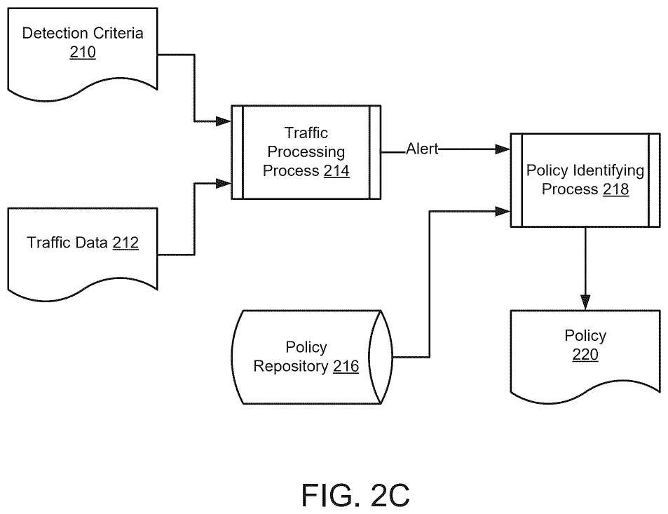

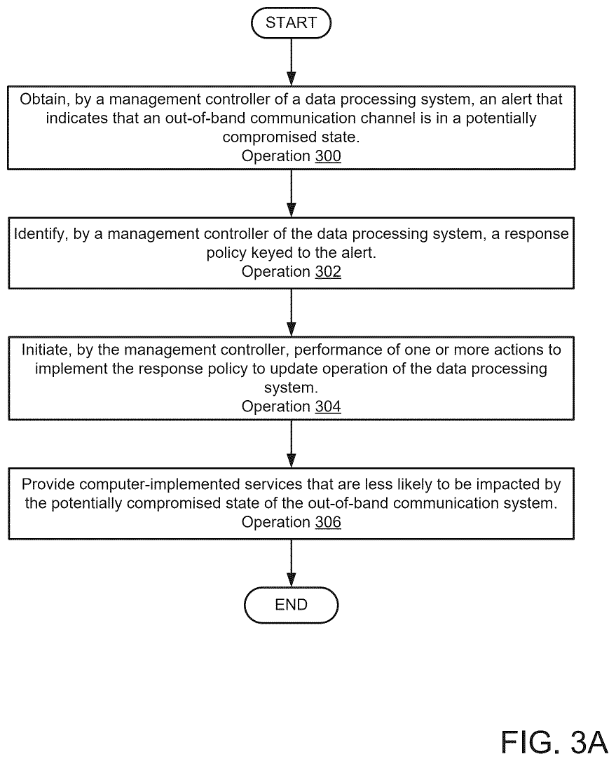

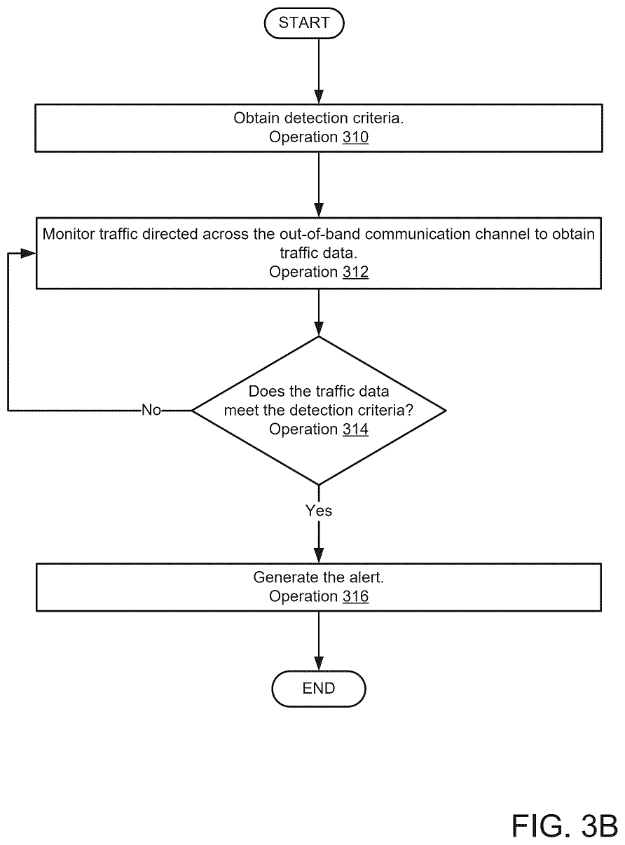

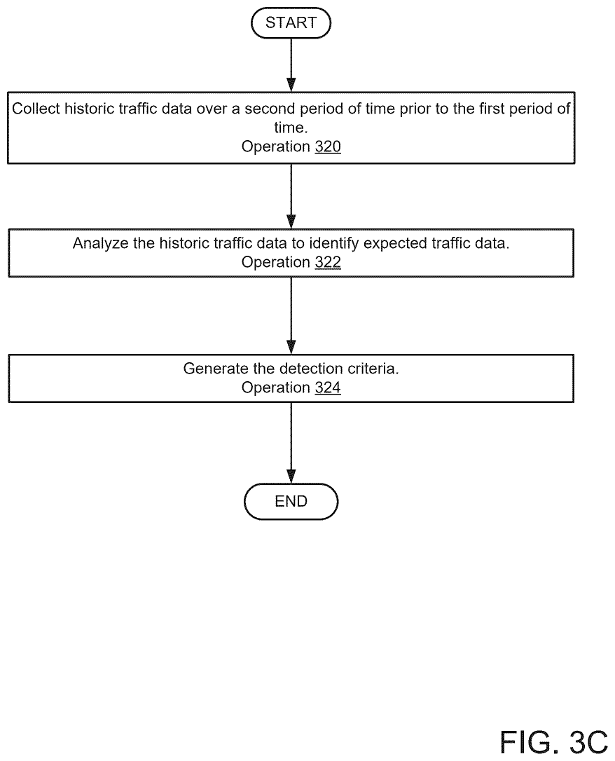

While providing their functionality, any of data processing systems 100 and/or server system 102 may provide all or a portion of the methods shown in FIGS. 2A-3C.

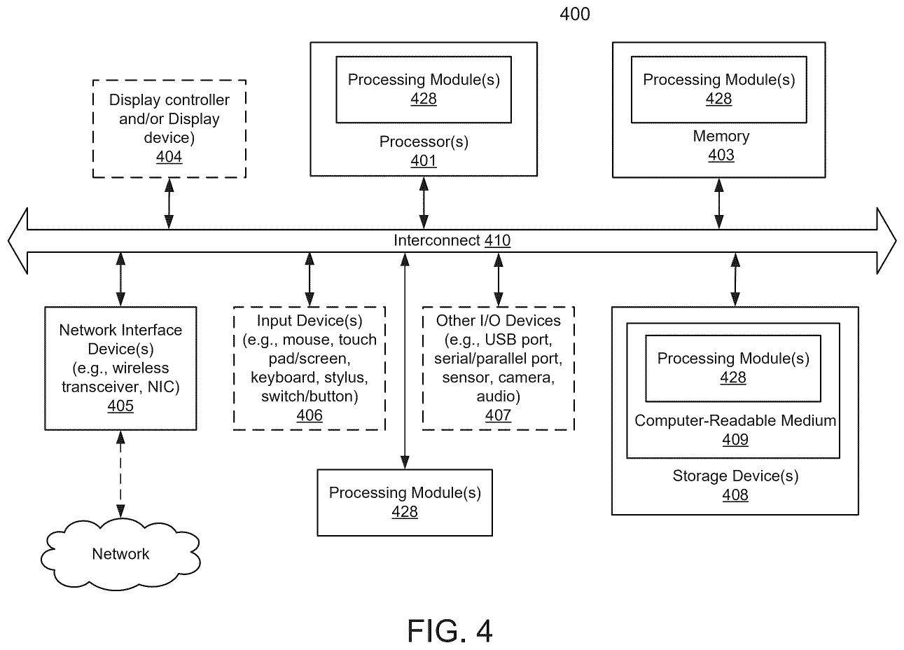

Communication system 104 may allow any of data processing systems 100, and server system 102 to communicate with one another (and/or with other devices not illustrated in FIG. 1A). To provide its functionality, communication system 104 may be implemented with one or more wired and/or wireless networks. Any of these networks may be a private network (e.g., the “Network” shown in FIG. 4), a public network, and/or may include the Internet. For example, client devices 100 may be operably connected to server devices 106 via the Internet. Data processing systems 100, server system 102, and/or communication system 104 may be adapted to perform one or more protocols for communicating via communication system 104.

Any of (and/or components thereof) data processing systems 100, and server system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1A, a system in accordance with an embodiment may manage data processing systems 100 by monitoring traffic directed across an out-of-band communication channel used by data processing systems 100. By doing so, malicious activity (e.g., network attacks) may be more likely to be detected and responded to (e.g., in a timely manner), and a quality and/or availability of computer-implemented services provided by data processing systems may be improved.

Turning to FIG. 1B, a diagram illustrating a data processing system in accordance with an embodiment is shown. Data processing system 100A shown in FIG. 1B may be similar to any of the data processing systems shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing hardware resources 150 to communicate with other devices via packet switched networks and/or other types of communication networks.

The processor may also host various applications that provide the computer-implemented services. The applications may utilize various services provided by the management entities and use (at least indirectly) the network stack to communication with other entities.

However, use of the network stack and the services provided by the management entities may place the applications at risk of indirect compromise. For example, if any of these entities trusted by the applications are compromised, these entities may subsequently compromise the operation of the applications. Additionally, if various drivers and/or the communication stack are compromised, communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

To reduce the likelihood of the applications and/or other in-band entities from being indirectly compromised, data processing system 100A may include management controller 152 and network module 160. Each of these components of data processing system 100A is discussed below.

Management controller 152 may be implemented, for example, using a system on a chip or other type of independently operating computing device (e.g., independent from the in-band components, such as hardware resources 150, of a host data processing system 100A). Management controller 152 may provide various management functionalities for data processing system 100A. For example, management controller 152 may monitor various ongoing processes performed by the in-band component, may manage power distribution, thermal management, and/or other functions of data processing system 100A.

To do so, management controller 152 may be operably connected to various components via sideband channels 174 (in FIG. 1B, a limited number of sideband channels are included for illustrative purposes, it will be appreciated that management controller 152 may communication with other components via any number of sideband channels). The sideband channels may be implemented using separate physical channels, and/or with a logical channel overlay over existing physical channels (e.g., logical division of in-band channels). The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152. Management controller 152 may then, for example, send the information via sideband channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similar processes may be used to facilitate outbound communications from the applications.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

To facilitate communication with other devices, data processing system 100A may include network module 160. Network module 160 may provide communication services for in-band components and out-of-band components (e.g., management controller 152) of data processing system. To do so, network module 160 may include traffic manager 162 and interfaces 164.

Traffic manager 162 may include functionality to (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, that may independently addressable, and otherwise unrelated to one another.

To provide its functionality, management controller 152 may rely on information received from other devices via communication over an out-of-band communication channel (e.g., 172). However, malicious entities may attempt to disrupt the communications by performing a network attack (e.g., a distributed denial of service attack) that may flood the out-of-band communication channel with unexpected traffic (e.g., malicious and/or overwhelmingly high levels of traffic). Communications disrupted by malicious activity may negatively impact functionalities provided by management controller 152.

To improve a resiliency against the malicious activity, management controller 152 may monitor traffic directed across an out-of-band communication channel to identify when a network attack may be occurring. When the network attack is identified to be occurring, management controller 152 may initiate a response policy designed to reduce an impact of the network attack. For example, management controller 152 may provide instruction to (i) disable operation of any components of hardware resources 150, (ii) block certain traffic directed through traffic manager 162, and/or any other actions.

When operating, any of these components (e.g., management controller 152, network module 160, etc.) may generate traffic data. Traffic data may include a level of traffic and/or traffic patterns of traffic (e.g., communication of information with other devices) traversing the out-of-band communication channel. Management controller 152 may analyze traffic data from past operation to generate detection criteria. The detection criteria may indicate unexpected traffic and may be used by management controller 152 to identify when a network attack may be occurring.

To facilitate management of data processing system 100A over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations illustrated in FIGS. 2A-3C.

While illustrated in FIG. 1B with a limited number of specific components, a system may include additional, fewer, and/or different components without departing from embodiments disclosed herein.

To further clarify embodiments disclosed herein, an interaction diagram in accordance with an embodiment is shown in FIG. 2A. The interaction diagram may illustrate processes performed within the system of FIGS. 1A-1B.

In the interaction diagram, processes performed by components of a system in accordance with an embodiment are shown. In the diagram, components of the system are illustrated using a first set of shapes (e.g., 150, 152, etc.), located towards the top of each figure. Lines descend from these shapes. Processes performed by the components of the system are illustrated using a second set of shapes (e.g., 200, 202, etc.) superimposed over these lines.

Generally, the processes are temporally ordered in an example order, with time increasing from the top to the bottom of each page. For example, the process labeled as 200 may occur prior to the process labeled as 202. However, it will be appreciated that the processes may be performed in different orders, any may be omitted, and other processes or interactions may be performed without departing from embodiments disclosed herein. Turning to FIG. 2A, a first interaction diagram in accordance with an embodiment is

shown. The first interaction diagram may illustrate processes that may occur during updating operation of a data processing system.

To update operation of the data processing system, traffic monitoring process 200 may be performed. During traffic monitoring process 200, traffic data may be collected. To collect traffic data, traffic (e.g., live traffic) directed to management controller 152 and/or network module 160 may be observed and characteristics of the traffic may be identified. The traffic may include messages sent between data processing system 100A and server system 102 to support operation of data processing system 100A. Management controller 152 may identify characteristics of the traffic to obtain the traffic data. For example, a level of the traffic, traffic patterns, and/or any other quantities and/or qualities of the traffic may be identified. Once obtained, the traffic data (e.g., traffic data 212) may be analyzed in traffic analysis process 202.

To analyze the traffic data, traffic analysis process 202 may be performed. During traffic analysis process 202, detection criteria may be obtained, the traffic data may be compared to the detection criteria, an alert may be obtained, and a response policy may be identified. The detection criteria may indicate unexpected traffic data directed across out-of-band communication channel 172A. The detection criteria may be generated prior to traffic analysis process 202 based on historic traffic data. Refer to FIG. 2B for additional details regarding generating the detection criteria.

Traffic data obtained from traffic monitoring process 200 that meets the detection criteria may indicate that out-of-band communication channel 172A is in a potentially compromised state. The potentially compromised state of out-of-band communication channel 172A may trigger an alert generated and/or obtained by management controller 152. A response policy keyed to the alert may be identified by management controller 152. Refer to FIG. 2C for additional details regarding traffic analysis process 202. Once obtained, the response policy may be implemented in policy implementation process 204.

To implement the response policy, policy implementation process 204 may be performed. During policy implementation process 204, computer instructions may be provided, and one or more actions may be performed based on the computer instructions. To provide the computer instructions, management controller 152 may send and/or receive information to any components of data processing system 100A (e.g., hardware resources 150, network module 160) and/or server system 102 regarding, for example, actions to be performed, an urgency of the actions, a time constraint for the actions (e.g., a service level agreement), and/or any other details of the response policy.

To perform the one or more actions, hardware resources 150 may utilize a processor to execute the computer instructions obtained from management controller 152 to attempt to remediate the potentially compromised state of out-of-band communication channel 172A. For example, the one or more actions may include (i) disabling operation of a component of hardware resources 150, (ii) filtering traffic traversing out-of-band communication channel 172A to remove undesired traffic, (iii) initiating performance of a forensics process to attempt to remediate a cause of the potentially compromised state, and/or any other actions.

Out-of-band communication channel 172A may be used to direct traffic between management controller 152, network module 160, and/or server system 102. Out-of-band communication channel 172A may support a management schema between management controller 152 and server system 102. Unexpected traffic (e.g., higher than expected levels of traffic, malicious traffic, etc.) detected during traffic analysis process 202 may place out-of-band communication channel 172A in a potentially compromised state and disrupt the management schema. However, the one or more actions performed during policy implementation process 204 may remediate a cause of the potentially compromised state and improve a quality and/or availability of computer-implemented services provided by data processing system 100A.

Sideband communication channel 174A may be used to interface with and/or provide instructions between management controller 152 and hardware resources 150 when performing the one or more actions during policy implementation process 204 to place out-of-band communication channel 172A in a second operating state less likely to be impacted by a potentially compromised state.

To further clarify embodiments disclosed herein, data flow diagrams in accordance with an embodiment are shown in FIGS. 2B-2C. In these diagrams, flows of data and processing of data are illustrated using different sets of shapes. A first set of shapes (e.g., 210, 212, etc.) is used to represent data structures, a second set of shapes (e.g., 206, 208, etc.) is used to represent processes performed using and/or that generate data, and a third set of shapes (e.g., 216) is used to represent large scale data structures such as databases.

Turning to FIG. 2B, a first data flow diagram in accordance with an embodiment is shown. The first data flow diagram may illustrate data used in and data processing performed in generating detection criteria that may indicate an out-of-band communication channel is in a potentially compromised state.

To generate detection criteria, traffic data collection process 206 may be performed. During traffic data collection process 206, historic traffic data directed across out-of-band communication channel 172A may be observed and collected over a period of time (e.g., prior to traffic monitoring process 200). The historic traffic data may be stored and/or used in detection criteria generating process 208 to identify unexpected traffic data based on the historic traffic data.

To identify unexpected traffic data, detection criteria generation process 208 may be performed. During detection criteria generation process 208, the historic traffic data may be analyzed, and detection criteria may be generated. To analyze the historic traffic data, any number and/or type of metrics may be computed using the historic traffic data. For example, levels of traffic of the historic traffic data may be computed to obtain an average level of traffic, a maximum level of traffic, and/or any other levels of traffic likely to traverse out-of-band communication channel 172A during normal operation. Furthermore, traffic patterns, sources of traffic, and/or any other qualities of the historic traffic data may be identified to indicate expected traffic data. To generate the detection criteria, the analyzed historic traffic data may be used to identify criteria for unexpected traffic data. For example, a threshold may be established based on the expected traffic data and/or a buffer may be added to the expected traffic data to generate the detection criteria for unexpected traffic data.

Furthermore, the detection criteria may be updated based on additional traffic data collected after the first period of time (e.g., current time). To update the detection criteria, additional traffic data may be collected (similar to traffic data collection process 206) and analyzed to generate updated detection criteria. The updated detection criteria may improve a quality (e.g., accuracy) when used to determine whether the out-of-band communication channel may be in a potentially compromised state (e.g., under a distributed denial of service attack) while monitoring traffic during a future period of time.

Thus, using the data flows shown in FIG. 2B, detection criteria may be generated that may be used to identify when a network attack may be occurring. By using the detection criteria when monitoring traffic directed across an out-of-band communication channel, network attacks may be more likely to be detected and responded to in a timely manner.

Turning to FIG. 2C, a second data flow diagram in accordance with an embodiment is shown. The second data flow diagram may illustrate data used in and data processing performed in responding to a potential network attack.

Traffic data 212 may be obtained during traffic monitoring process 200 and may include any type and quantity of information regarding traffic direct across an out-of-band communication channel. For example, traffic data 212 may include a level of the traffic, traffic patterns, and/or any other metrics of the traffic.

To respond to a potential network attack, traffic processing process 214 may be performed. During traffic processing process, traffic data 212 may be compared to detection criteria 210, and an alert may be generated. To compare traffic data 212 to detection criteria 210, a value and/or quality of traffic data 212 may be compared to detection criteria 210 to determine if the value and/or quality of traffic data 212 meets (e.g., equal or greater) detection criteria 210. If traffic data 212 meets detection criteria 210, an alert may be generated. For example, consider a scenario in which detection criteria 210 includes a threshold of 100 messages/second. In this scenario, if traffic data 212 indicates that a level of traffic traversing out-of-band communication channel is 100 messages/second, then the detection criteria has been met and an alert may be generated. To generate the alert, a message may be generated by and/or provided to management controller 152 through (i) transmission via a message, (ii) a publish-subscribe system, and/or any other processes. Once obtained, the alert may be used in policy identifying process 218 to identify a policy keyed to the alert.

To identify a policy keyed to the alert, policy identifying process 218 may be performed. During policy identifying process 218, a policy lookup may be performed. To perform the policy lookup, policy repository 216 may be searched to identify a policy usable to respond to the alert obtained from traffic processing process 214. For example, the alert may be used as a key (e.g., an alert identifier) to identify the policy. Policy repository 216 may include any number and type of response policies that may be obtained by a management controller of a data processing system. Policy repository 216 may include, for example, (i) a database, (ii) an interface with listed policies, and/or any other data structure. Once identified from policy repository 216, policy 220 may be obtained and provided to the management controller.

Policy 220 may include any number and type of information regarding a response to the alert indicating that the out-of-band communication channel may be in a potentially compromised state. For example, policy 220 may include one or more actions to be performed to attempt to remediate the potentially compromised state of the out-of-band communication channel, an urgency of the one or actions, a time constraint for the one or more actions (e.g., a service level agreement), and/or any other details.

Thus, using the data flows shown in FIG. 2C, operation of a data processing system may be updated to improve computer-implemented services based on one or more actions provided by a response policy when traffic directed across an out-of-band communication channel is determined to indicate a network attack.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1A may perform various methods to manage a data processing system. FIGS. 3A-3C illustrate methods that may be performed by the components of the system of FIGS. 1A-1B. In the diagrams discussed below and shown in FIGS. 3A-3C, any of the operations may be repeated, performed in different orders, and/or performed in parallel with or in a partially overlapping in time manner with other operations.

Turning to FIG. 3A, a first flow diagram illustrating a method of managing a data processing system in accordance with an embodiment is shown. The method may be performed, for example, by any of the components of the system of FIGS. 1A-1B, and/or other components not shown therein.

At operation 300, an alert may be obtained that indicates that an out-of-band communication channel is in a potentially compromised state. The alert may be obtained by (i) obtaining detection criteria, (ii) monitoring traffic directed across the out-of-band communication channel to obtain traffic data, (iii) making a determination regarding whether the traffic data meets the detection criteria, (iv) generating the alert in the first instance in which the traffic data meets the detection criteria, and/or any other processes. Refer to FIG. 3B for additional details regarding obtaining the detection criteria.

At operation 302, a response policy keyed to the alert may be identified. The response policy may be identified by (i) accessing a policy repository, (ii) searching the policy repository for the response policy keyed to the alert, (iii) transmitting a message to request the response policy, and/or any other method.

At operation 304, performance of one or more actions to implement the response policy may be initiated. The performance of the one or more actions may be initiated by (i) obtaining (e.g., generating) instructions based on the response policy, (ii) transmitting the instructions to any hardware resources of the data processing system, (iii) executing the instructions in order to update operation of the data processing system, and/or any other processes.

The one or more actions may include (i) disabling operation of a hardware resource of the data processing system to attempt to reduce impacts of the potentially compromised state, (ii) notifying an entity tasked with managing operation of the data processing system, (iii) initiating performance of a forensics process, and/or any other actions.

At operation 306, computer-implemented services that are less likely to be impacted by the potentially compromised state of the out-of-band communication channel may be provided. The computer-implemented services may be provided by (i) resuming use of the out-of-band communication channel, (ii) operating the data processing system under an updated state (e.g., that may be more resistant to undesired use than the prior operation), and/or other processes.

The method may end following operation 306.

Using the method shown in FIG. 3A, the likelihood of a potentially compromised state of an out-of-band communication channel impacting computer-implemented services may be reduced by obtaining an alert and implementing one or more actions of a response policy based on the alert.

Turning to FIG. 3B, a second flow diagram illustrating a method of obtaining an alert in accordance with an embodiment is shown. The method may be performed, for example, by any of the components of the system of FIGS. 1A-1B, and/or other components not shown therein.

At operation 310, detection criteria may be obtained. The detection criteria may be obtained by (i) transmitting a message requesting the detection criteria, (ii) retrieving the detection criteria from storage, and/or any other methods. The detection criteria may be also obtained and/or generated prior to obtaining the alert by (i) collecting historic traffic data over a second period of time prior to the first period of time, (ii) analyzing the historic traffic data, and generating the detection criteria. Refer to FIG. 3C for additional details regarding obtaining the detection criteria.

At operation 312, traffic directed across the out-of-band communication channel may be monitored to obtain traffic data. The traffic may be monitored by (i) collecting traffic data from the management controller of the data processing system and/or a network module of the data processing system, (ii) using traffic monitor tools, (iii) accessing traffic logs, and/or any other methods.

At operation 314, a determination may be made regarding whether the traffic data meets the detection criteria. The determination may be made by (i) comparing a level of traffic of the traffic data the detection criteria, (ii) comparing a quality (e.g., a pattern) of the traffic data to the detection criteria, (iii) determining if the result of the comparison meets (e.g., equal or greater) the detection criteria, and/or any other methods. If the traffic data meets the detection criteria (e.g., the determination is “Yes” at operation 312), then the method may proceed to operation 316. If the traffic data is determined to not meet the detection criteria (e.g., the determination is “No” at operation 312), then the method may return to operation 312 (e.g., continue monitoring traffic directed across the out-of-band communication channel).

At operation 316, the alert may be generated. The alert may be generated by (i) transmitting a message indicating that the traffic directed across the out-of-band communication channel may include unexpected traffic data, (ii) subscribing to updates from a management controller of the data processing system, and/or any other processes.

The method may end following operation 316.

Using the method shown in FIG. 3B, an alert may be generated (e.g., provided to a management controller of the data processing system) when traffic data from traffic directed across an out-of-band communication channel meets detection criteria.

Turning to FIG. 3C, a third flow diagram illustrating a method of obtaining detection criteria in accordance with an embodiment is shown. The method may be performed, for example, by any of the components of the system of FIGS. 1A-1B, and/or other components not shown therein.

At operation 320, historic traffic data over a second period of time prior to the first period of time may be collected. The historic traffic data may be collected by (i) collecting traffic data from the management controller of the data processing system and/or a network module of the data processing system over a period of time, (ii) storing the historic traffic data in a database, and/or any other methods.

At operation 322, the historic traffic data may be analyzed to identify expected traffic data. The historic traffic data may be analyzed by (i) performing mathematical operations (e.g., statistical) on the historic traffic data to obtain an expected level of traffic during normal operation (e.g., average, maximum, etc.), (ii) modeling the historic traffic data to recognize patterns (e.g., short periods of increased traffic for certain durations), and/or any other processes.

At operation 324, the detection criteria may be generated. The detection criteria may be generated by (i) determining a threshold for unexpected traffic based on the expected traffic of the historic traffic data, (ii) adding a buffer to the expected traffic data, (iii) using inference models to obtain unexpected behaviors of traffic data, and/or any other methods.

The method may end following operation 324.

Using the method shown in FIG. 3B, detection criteria may be generated to indicate unexpected traffic directed across an out-of-band communication channel. The detection criteria may be used to indicate that the out-of-band communication channel is in a potentially compromised state (e.g., under a distributed denial of service attack).

Any of the components illustrated in FIGS. 1A-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing a data processing system, the method comprising:
obtaining, by a management controller of the data processing system while the data processing system operates in a first operating state, an alert that indicates that an out-of-band communication channel is in a potentially compromised state;
identifying, by the management controller, a response policy keyed to the alert, the response policy comprising one or more actions to be performed based on the alert;
initiating, by the management controller, performance of the one or more actions to implement the response policy to update operation of the data processing system to place the data processing system in a second operating state; and
providing, by the data processing system while operating in the second operating state, computer-implemented services that are less likely to be impacted by the potentially compromised state of the out-of-band communication channel than if the data processing system was operating in the first operating state.

2. The method of claim 1, wherein obtaining the alert comprises:
obtaining detection criteria, the detection criteria indicating unexpected traffic data;
monitoring traffic directed across the out-of-band communication channel to obtain first traffic data over a first period of time, the traffic comprising messages sent between a data processing system and a server system to support operation of the data processing system;
making a determination regarding whether the first traffic data meets the detection criteria; and
in the first instance of the determination in which the first traffic data meets the detection criteria:
generating the alert.

3. The method of claim 2, wherein the out-of-band communication channel is in the potentially compromised state when the first traffic data meets the detection criteria.

4. The method of claim 2, wherein monitoring the traffic comprises obtaining the first traffic data collected from the management controller of the data processing system and/or a network module of the data processing system.

5. The method of claim 2, wherein traffic data comprises at least one type of traffic data selected from a group of traffic data consisting of:
a level of traffic directed across the out-of-band communication channel; and
traffic patterns for traffic directed across the out-of-band communication channel.

6. The method of claim 5, wherein obtaining the detection criteria comprises:
prior to obtaining the alert:
collecting historic traffic data over a second period of time prior to the first period of time;
analyzing the historic traffic data to identify at least an expected level of traffic likely to traverse the out-of-band communication channel or a traffic pattern likely to traverse the out-of-band communication channel; and
generating the detection criteria based at least on the expected level of traffic likely to traverse the out-of-band communication channel.

7. The method of claim 6, wherein the detection criteria are updated based on additional traffic data collected over a third period of time after the first period of time.

8. The method of claim 1, wherein the out-of-band communication channel supports a management schema between the management controller of the data processing system and a server system and the potentially compromised state of the out-of-band communication channel causes a disruption to the management schema.

9. The method of claim 8, wherein the disruption to the management schema negatively impacts the computer-implemented services provided by the data processing system while operating in the first operating state.

10. The method of claim 1, wherein the one or more actions of the response policy comprise at least one type of action selected from a group of actions consisting of:
disabling operation of a hardware resource of the data processing system to attempt to reduce impacts of the potentially compromised state;
notifying an entity tasked with managing operation of the data processing system to attempt to remediate the potentially compromised state; and
initiating performance of a forensics process to attempt to remediate a cause of the potentially compromised state.

11. The method of claim 1, wherein the potentially compromised state is due to a network attack, the network attack comprising at least one type of attack selected from a group of types of attacks consisting of:
a distributed denial of service against the management controller; and
a denial of service against the management controller.

12. The method of claim 1, wherein the data processing system comprises hardware resources and a network module adapted to separately advertise network endpoints for the management controller and the hardware resources of the data processing system, the network endpoints being usable by a server system to address communications to the hardware resources using an in-band communication channel and the management controller using an out-of-band communication channel.

13. The method of claim 12, wherein the management controller and the network module are on separate power domains from the hardware resources so that the management controller and the network module are operable while the hardware resources are inoperable.

14. The method of claim 12, wherein the out-of-band communication channel runs through the network module, and an in-band communication channel that services the hardware resources also runs through the network module.

15. The method of claim 12, wherein the network module hosts a transmission control protocol/internet protocol (TCP/IP) stack to facilitate network communications via the out-of-band communication channel.

16. A non-transitory machine-readable medium having instructions stored therein, which when executed by a processor, cause the processor to perform operations for managing a data processing system, the operations comprising:
obtaining, by a management controller of the data processing system while the data processing system operates in a first operating state, an alert that indicates that an out-of-band communication channel is in a potentially compromised state;
identifying, by the management controller, a response policy keyed to the alert, the response policy comprising one or more actions to be performed based on the alert;
initiating, by the management controller, performance of the one or more actions to implement the response policy to update operation of the data processing system to place the data processing system in a second operating state; and
providing, by the data processing system while operating in the second operating state, computer-implemented services that are less likely to be impacted by the potentially compromised state of the out-of-band communication channel than if the data processing system was operating in the first operating state.

17. A non-transitory machine-readable medium of claim 16, wherein obtaining the alert comprises:
obtaining detection criteria, the detection criteria indicating unexpected traffic data;
monitoring traffic directed across the out-of-band communication channel to obtain first traffic data over a first period of time, the traffic comprising messages sent between a data processing system and a server system to support operation of the data processing system;
making a determination regarding whether the first traffic data meets the detection criteria; and
in the first instance of the determination in which the first traffic data meets the detection criteria:
generating the alert.

18. A non-transitory machine-readable medium of claim 16, wherein the out-of-band communication channel is in the potentially compromised state when the first traffic data meets the detection criteria.

19. A data processing system, comprising:
a processor; and
a memory coupled to the processor to store instructions, which when executed by the processor, cause the processor to perform operations for managing the data processing system, the operations comprising:
obtaining, by a management controller of the data processing system while the data processing system operates in a first operating state, an alert that indicates that an out-of-band communication channel is in a potentially compromised state;
identifying, by the management controller, a response policy keyed to the alert, the response policy comprising one or more actions to be performed based on the alert;
initiating, by the management controller, performance of the one or more actions to implement the response policy to update operation of the data processing system to place the data processing system in a second operating state; and
providing, by the data processing system while operating in the second operating state, computer-implemented services that are less likely to be impacted by the potentially compromised state of the out-of-band communication channel than if the data processing system was operating in the first operating state.

20. The data processing system of claim 19, wherein obtaining the alert comprises:
obtaining detection criteria, the detection criteria indicating unexpected traffic data;
monitoring traffic directed across the out-of-band communication channel to obtain first traffic data over a first period of time, the traffic comprising messages sent between a data processing system and a server system to support operation of the data processing system;
making a determination regarding whether the first traffic data meets the detection criteria; and
in the first instance of the determination in which the first traffic data meets the detection criteria:
generating the alert.
